(19) United States
(12) Patent Application Publication
(10) Pub. No.: US 2004/0023675 A1
(43) Pub. Date: Feb. 5, 2004

(54) Methods and apparatus for selecting a channel for communicating with a remote wireless device

(76) Inventor: Wilhelm Ernst Riedl, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/209,033

(22) Filed: Jul. 31, 2002

(51) Int. Cl. H04Q 7/20

(52) U.S. Cl. 455/464; 455/509

(57) ABSTRACT

An apparatus and method for selecting a new channel for communicating with a remote wireless device in which the quality of data transmitted on a communication channel simultaneously with audio information is used to determine whether the new communication channel should be selected.

### FIELD OF THE INVENTION

The present invention relates generally to analog cordless telephone systems and other various devices, such as intercoms, computers, and televisions; and more particularly to devices that are configured to communicate via at least one of a plurality of available radio frequency channels.

### DESCRIPTION OF THE RELATED ART

Conventional communications devices such as cordless telephone systems may encounter poor audio quality due to external interference on the frequency channels at which the cordless telephone is operating. To select a new channel, a user must typically press a button on the handset or mobile portion of the cordless telephone system to effect a change in communication channels. During such a change, the audio path is typically muted.

Conventional 9 MHz or 2.4 GHz region residential cordless telephone systems may also provide a clear channel selection mechanism using as a measure a received signal strength indication (RSSI) provided by the system hardware. The RSSI evaluation of a channel is typically performed during a “stand-by” mode of operation, since the manual change mode is utilized during the “in-use” state of operation. The RSSI indicates the loss or lack of received signal power and may be used to indicate that the link margin of a communications channel is inadequate or that the link should be terminated.

In the German CTI 900 MHz region analog cordless telephone system, a data packet is intermittently exchanged between a cordless telephone handset and base unit. Unfortunately, such transfer of the data packet causes annoying disruption of communication to the user, since the audio path is muted during this process.

### SUMMARY OF THE INVENTION

A method and apparatus for selecting a new channel for communicating with a remote wireless device in which the quality of data transmitted on a communication channel simultaneously with audio information is used to determine whether the new communication channel should be selected.

In a wireless communications system utilizing a plurality of communications channels, each channel having associated with it a respective carrier frequency for propagating audio data in a first spectral region and non-audio data in a second spectral region, a method according to an embodiment of the invention comprises selecting an initial communications channel for communicating with a desired wireless device; (b) determining if a received signal strength indicator (RSSI) of the selected communications channel indicates that the desired wireless device is active; (c) transmitting, via the selected communications channel, an identification code of the active wireless device, the identification code comprising non-audio data; (d) repeating step (c) up to a predetermined number of times until the desired wireless device has responded to the transmitted identification code; and (e) if the desired wireless device has not responded to the transmitted identification code, selecting a next communications channel and repeating steps (a) through (d).

### BRIEF DESCRIPTION OF THE DRAWINGS

A more complete understanding of the present invention may be obtained from consideration of the following description in conjunction with the drawings, in which:

FIG. 1 depicts a high level block diagram of a wireless communication system according to an embodiment of the invention; FIG. 2 depicts a high level block diagram of an exemplary controller suitable for use in the system of FIG. 1;

FIG. 3 depicts a high level block diagram of a wireless communications device such as a base station or hand set suitable for use in the wireless communication system of FIG. 1;

FIG. 4 depicts a flow diagram of a method according to the invention and suitable for use in a base station; and

FIG. 5 depicts a flow diagram of a method suitable for use in a handset or mobile device.

To facilitate understanding, identical reference numerals have been used, where possible, to designate identical elements that are common to the figures.

### DETAILED DESCRIPTION

The present invention will be described within the context of a cordless telephone system having a base unit in communication with a handset via one of a plurality of available wireless communications channels. It will be appreciated by those skilled in the art that the teachings of the present invention may be readily adapted to any system in which one or more of a plurality of available communications channels may be selected for voice or other audio communications. It will also be appreciated by those skilled in the art that the invention may be practiced within a system in which multiple handsets are employed, multiple base units are employed and/or multiple communications devices are employed.

Moreover, although the invention will be described within the context of direct communication between a remote wireless device such as a cordless telephone handset or an intercom, indirect communications may take place between the remote wireless intercom and/or a cordless headset through the cordless base station using base-to-handset and handset-to-base communications. In this case, what is displayed or heard at the cordless base station may optionally be displayed or heard at the cordless handset(s).

It is noted that further modifications can be made to the described embodiments and that such modifications are contemplated by the inventor.

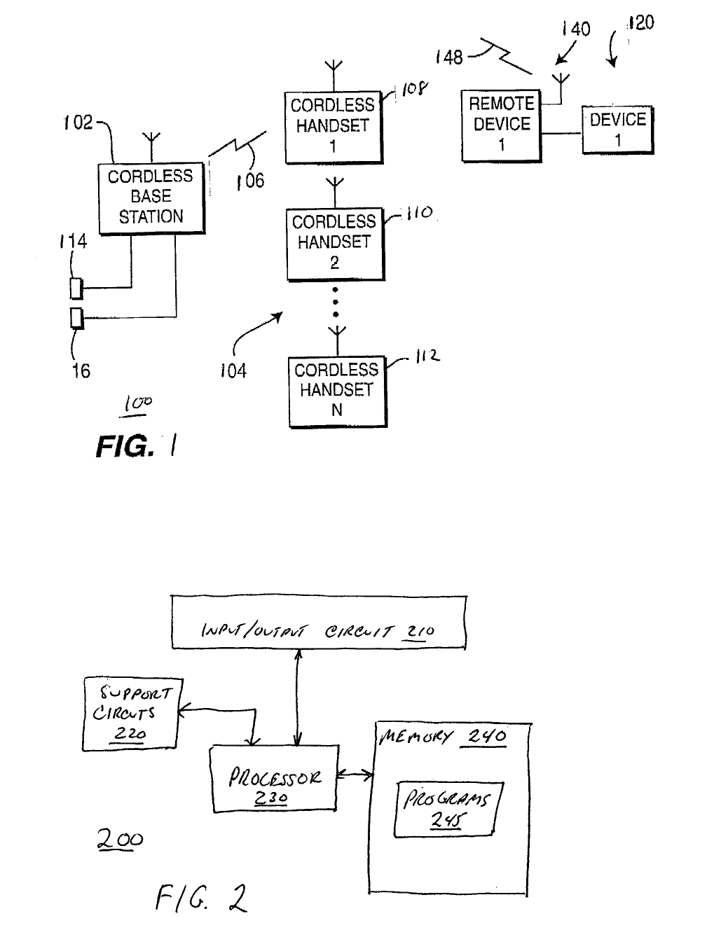

FIG. 1 depicts a high level block diagram of a wireless communication system, illustratively a cordless telephone system 100, as well as at least one device 120 and at least one remote wireless device 140. Cordless telephone system 100 includes a cordless base station 102, which may be referred to as a cordless base unit, and a plurality of cordless handsets 104, each of which may be referred to as a cordless telephone unit. The plurality of cordless handsets 104 includes cordless handsets 108-112, designated as cordless handsets 1 through N in FIG. 1.

Cordless telephone system 100 provides for wireless telephone communications within a relatively small geographical area for an end-user. Cordless base station 102 and cordless handset 108 communicate with each other via radio frequency (RF) signals 106. Cordless base station 102 has an interface for coupling to an alternating current (AC) power source 114, such as that commonly provided in a home residence or business. Cordless base station 102 has another interface for coupling to land line 116, which couples cordless base station 102 to the public switched telephone network (PSTN) for land line telephone communication.

Cordless handset 108, which is representative of other cordless handsets 110-112, typically includes a user interface which includes a speaker, a microphone, a display, and a keypad having conventional dual-tone multiple frequency (DTMF) keys for dialing. Cordless base station 102 optionally has the same or similar interface. Thus, cordless base station 102, cordless handset 108, or both devices can be used to make and receive telephone calls.

The remote device 140 and device 120 may comprise any device compatible with cordless telephone system 100. The device 120 may comprise devices such as an intercom installed in a home residence or business, a computer such as a personal computer (PC) or laptop (with or without browser software for the Internet or WWW), an AM/FM radio (including its associated tape and CD players) and its remote controllers, a television and its remote controllers, a video camera recorder (VCR) and its remote controllers, and sensors such as temperature sensors, weather sensors, and motion detection sensors. Although devices 120 and remote wireless devices 140 are shown as separate devices in FIG. 2, they may be integrated into a single device and/or housing, such as a remote wireless intercom.

A more detailed and expanded explanation of the wireless communication system 100 of FIG. 1 including Data over Voice (DoV) hardware is provided within commonly-assigned U.S. patent application Ser. No. 10/007,242 (Attorney Docket No. PTU00002), which was filed on Nov. 9, 2001 and entitled “METHODS AND APPARATUS FOR COMMUNICATION INFORMATION FROM A REMOTE WIRELESS DEVICE TO A CORDLESS TELEPHONE SYSTEM,” which patent application is incorporated herein by reference in its entirety. The disclosed methods and apparatus in this patent application relate to a wireless communication system enabling, for example, a cordless telephone system to communicate with a plurality of other devices, such as intercoms, computers, televisions and the like.

The wireless communication system 100 of FIG. 1 utilizes the concurrent or simultaneous transmission of audio or voice information and non-audio or non-voice information. Specifically, within the context of this disclosure, voice or audio information comprises band-limited analog audio information modulated onto a radio frequency (RF) carrier signal in a first spectral region relative to the carrier signal. Non-audio information comprises, illustratively, an encoded data signal that is modulated onto the carrier frequency in a second spectral region relative to the carrier signal.

In one embodiment of the invention, voice or audio information is carried in a first spectral region of approximately 0 to 4 KHz from a carrier frequency fc, while non-audio data is carried in a second spectral region having a 1 KHz bandwidth and offset from the carrier frequency f_{c} by approximately 10 KHz. Other spectral allocations may be employed with the context of the present invention. Moreover, while analog audio information may be readily modulated onto a carrier frequency and, therefore, simply transported within the first spectral region, it is also contemplated by the inventors that data may be transported within the first spectral region (or a reduced first spectral region) while audio information may be transported within the second spectral region (or an expanded second spectral region).

Within the context of the wireless communication system 100 of FIG. 1, the subject invention utilizes degradations within the non-audio information transported via the second spectral region to determine whether channel impairments or other anomalies likely impinge upon or otherwise reduce the fidelity of the audio or voice information carried within the first spectral region. Channel selection decisions are made in response to such degradation.

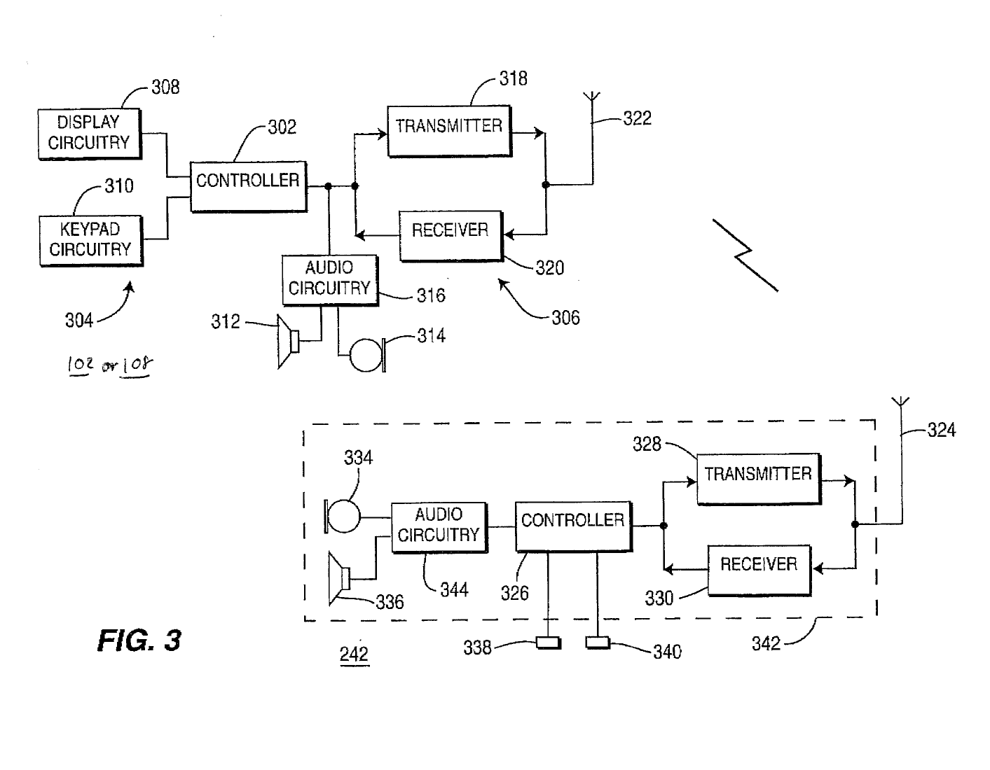

FIG. 2 depicts a block of an exemplary controller suitable for use in the system of FIG. 1. Specifically, the exemplary controller 200 in FIG. 2 comprises a processor 230 as well as memory 240 for storing various programs 245. The processor 230 cooperates with conventional support circuitry 220 such as power supplies, clock circuits, cache memory and the like as well as circuits that assist in executing a software routine stored in the memory 240. As such, it is contemplated that some of the process steps discussed herein as software processes may be implemented within hardware, for example, as circuitry that cooperates with the processor 230 to perform various steps. The controller 200 also contains input/output (I/O) circuitry 210 that forms an interface between the various functional elements communicating with the controller 200. For example, in an embodiment of the cordless base station 102 of FIG. 1 discussed below with respect to FIG. 3, the controller 200 of FIG. 2 is utilized as a controller 302 of FIG. 3, which controller 302 is coupled to display circuitry 308, keypad circuitry 310, a transmitter 318 and other circuitry via the I/O circuit 210.

More generally, the controller 200 of FIG. 2 may be advantageously employed as any controller element discussed herein.

FIG. 3 depicts a high level block diagram of apparatus suitable for use as any of cordless base station 102, cordless handset 108 or remote wireless device 140 of FIG. 1. The schematic block diagram is illustrated for either cordless base station 102 or cordless handset 108 since similar components exist in each device. In the following description, the schematic diagram of FIG. 3 will be referred to as illustrating cordless handset 108.

As shown, cordless handset 108 of FIG. 3 includes electrical components such as a controller 302, user interface circuitry 304, and transceiver circuitry 306. User interface circuitry 304 includes display circuitry 308 for use in connection with a visual display such as a Liquid Crystal Display (LCD), keypad circuitry 310 for use in connection with a keypad, and audio circuitry 316 for use in connection with a speaker 312 and a microphone 314. Transceiver circuitry 306 includes a transmitter 318, a receiver 320, and an antenna 322. Transceiver circuitry 306 uses RF techniques for communication and, in particular, frequency modulation (FM) techniques. Preferably, transceiver circuitry 306 utilize FM techniques in the 900 MHz or 2.4 GHz Industrial, Scientific, and Medical (ISM) bands. Alternatively, transceiver circuitry 306 may utilize other well-known communication techniques, such as Time Division Multiple Access (TDMA) or Code Division Multiple Access (CDMA) communication schemes.

Basic operation of cordless handset 108 of FIG. 3 is now described. When an end-user of cordless handset 108 is engaged in a telephone call, the end-user speaks or conveys audible voice signals into microphone 314 which provides low-level analog signals to audio circuitry 316 for processing the information. This information is conveyed to transmitter 318 and transmitted through antenna 322 via RF signals to cordless base station 102 (FIG. 1). On the other hand, cordless handset 108 of FIG. 3 receives RF signals from cordless base station 102 (FIG. 1) through antenna 322 and receiver 320 which processes them and provides them to audio circuitry 316.

Audio circuitry 316 processes these signals and provides them to speaker 312, which generates audible voice signals for the end-user. Controller 302 provides general control over transmitter 318, receiver 320, and audio circuitry 316 as needed.

The keypad which is used with keypad circuitry 310 typically includes conventional telephone keys (i.e., dual-tone multiple frequency or DTMF keys 0-9, *, and #) as well as control keys. The end-user initiates telephone calls by pressing the keys of the keypad, where keypad circuitry 310 uniquely detects each key that is pressed and provides this information to controller 302. Controller 302 then passes this DTMF key selection data to transmitter 318 in suitable form so that it can be transmitted from antenna 322 to cordless base station 102 (FIG. 1). In response, cordless base station 102 (FIG. 1) generates DTMF tones based on the DTMF key selection data for originating the telephone call. The keypad is used for other reasons as well, such as for changing the channel that cordless base station 102 and handset 108 use for communications.

The visual display (e.g., LCD) which is used with display circuitry 308 confirms the identification of the keys that were pressed by visually displaying them upon actuation. The visual display also displays other useful information to the end-user, such as caller identification (ID) information, the current date and time, as well as the current channel number. The caller ID information is transmitted to cordless handset 208 from cordless base station 102 (FIG. 1) when a telephone call over the PSTN is received. Controller 302 receives such data from receiver 320 and passes it in suitable form to display circuitry 308 for display.

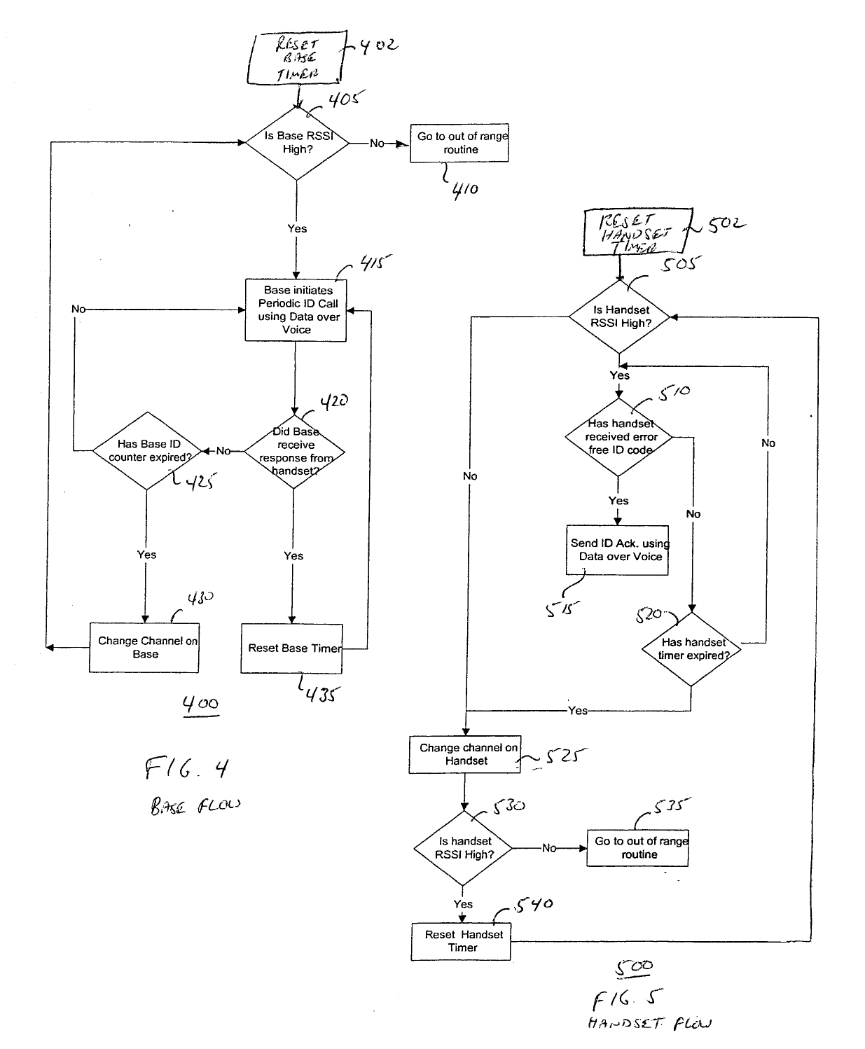

Within the context of the present invention, the simultaneous transmission of audio and non-audio information by the first and second spectral regions of a carrier frequency forms a single communication channel between, for example, the base station 102 and a cordless handset 108 (or remote device 140/120). Within the context of the wireless communication system 100 of FIG. 1, a plurality of such communications channels are utilized, each communication channel having associated with it a carrier frequency Fc for propagating the audio and non-audio information within the respective first and second spectral regions. The embodiment of the invention discussed below with respect to FIGS. 4 and 5 are discussed within the context of base station communications with a cordless handset. However, any wireless communications system utilizing a plurality of channels including first and second spectral regions for carrying audio and non-audio data.

FIG. 4 depicts a flow diagram of a method according to the invention and suitable for use in a base station. The method 400 is entered at step 402 where a base timer is reset, and proceeds to step 405 where a query is made as to whether the RSSI of a mobile device in communication with the base station is above a threshold level. If the RSSI is below the threshold level, then the method 400 proceeds to an out-of-range routine 410. The out-of-range routine 410 may comprise, for example, a channel search routine, a re-acquisition routine and the like. The out-of-range routine 410 may provide error messages to a user via a base station display device.

If at step 405 the RSSI is above (or equal to) the threshold level, then at step 415 the base station initiates a periodic identification (ID) call using a Data over Voice technique. Specifically, irrespective of whether the voice or audio traffic is being carried in the first spectral region of the communications channel, the identification of the mobile device in communication with the base station is transmitted. The identification may comprise a data word or sequence of data words which the mobile device will recognize and respond to, thereby indicating that the mobile device in communications with the base station via this channel is mobile device associated with a specific identification word or sequence.

At step 420, a query is made as to whether the base station has received a response from a handset or other device intended to be communicating with the base station. If the query at step 420 is answered affirmatively, then the base timer is reset at step 435, and the method 400 proceeds to step 415. If the query at step 420 is answered negatively, then at 425 a query is made as to whether the base timer (e.g., a counting or timing device) has expired or otherwise reached a threshold count or time period. If the base timer has not expired, then the method 400 proceeds to step 415. If the base timer has expired, then the communications channel utilized by the base station is changed at step 430, and the method 400 returns to step 405.

In the base flow method 400 of FIG. 4, the RSSI signal as well as identity data associated with a handset or other wireless device is monitored. The quality of a selected communications channel may be monitored in a manner distinguishing between an interfering signal and a desired signal. Briefly, a base station and remote device such as a handset periodically exchange identity information using the Data over Voice circuitry and methods described above. For example, assume that a base station initiated an ID call in response to a determination that RSSI above a threshold level exists, and the handset replies with an acknowledged command. Such reply implicitly acknowledges that the handset received information from the base station and that the information was received without errors. If the handset receives information from the base station that includes errors, then the handset does not reply with an acknowledged command.

Optionally, the acknowledged command provided by the handset includes an optional error message indicative of the type of error (e.g., poor RSSI at the handset, corrupted ID code, incorrect ID code, low battery indication and the like).

The base unit, while waiting for this “handshake” will re-transmit after a predetermined delay (e.g., no delay to several seconds) and try to repeat the process. If this process fails after being repeated a predefined number of times, then the base unit will change its channel and try to reestablish communications on a new frequency. The predetermined number of times is preferably selected in accordance with the delay. For example, if the base unit delay period is very small, then many attempts may be made before a user will find the delay in securing a channel objectionable. However, if the delay is large, then only a few repetitions are made before a user finds the total delay objectionable.

In one embodiment of the invention, the audio channel is muted during the time that the system is in the process of changing channels and remains muted until data communication resumes on the new frequency selected. Preferably, the overall time involved in the process of changing channels (i.e., the time during which an audio channel is muted) is of approximately the same duration as normally required for a manual channel change operation. Optionally, an indication is provided to a user via, for example, a display device on the base unit or handset indicative of the fact that the system is transferring communications to a new channel. The user indication may also comprise an audible indication such as a tone or beep. The entire process does not require user intervention.

FIG. 5 depicts a flow diagram of a method suitable for use in a handset or mobile device such as depicted above with respect to FIG. 1. The method 500 is entered at step 502, where a handset timer is reset, and proceeds to step 505 where a query is made as to whether the handset RSSI is above a threshold level. If the query at step 505 is answered negatively, then the method 500 proceeds to step 525.

If the query at step 505 is answered affirmatively, then at step 510 a query is made as to whether the handset has received an error free ID code from the base unit. If an error free ID code has been received, then at step 515 an ID acknowledgement is transmitted to the base station using the Data over Voice channel. If an error free ID code has not been received, then a query is made at step 520 as to whether a handset timer has expired. If the handset timer has not expired, then the method 500 proceeds to step 510. If the handset timer has expired, then the method 500 proceeds to step 525.

Optionally, the ID acknowledgement transmitted to the base station at step 515 includes an error message indicative of one or more specified errors, such as poor RSSI at the handset, corrupted ID code, incorrect ID code, low battery indication and the like.

At step 525 the communications channel utilized by the handset is changed, and at step 530 a determination is made as to whether the RSSI of the newly selected communications channel is above a threshold level. If the query at step 530 is answered negatively, then at step 535 an “out of range” routine is executed. If the query at step 530 is answered affirmatively, then at step 540 the handset timer is reset and the method 500 proceeds to step 505.

In alternate embodiments of the apparatus and methods discussed above, multiple threshold levels associated with the RSSI of one or both of the base station and handset or wireless devices are used. In these embodiments, where RSSI is marginal, new communication channels may be selected.

Although various embodiments which incorporate the teachings of the present invention have been shown and described in detail herein, those skilled in the art can readily devise many other varied embodiments that will still incorporate these teachings.

What is Claimed:

1. Apparatus, comprising:
a transmitter for simultaneously transmitting voice and data in respective spectral regions of a communications channel, said data comprising an identification code associated with a desired wireless device; And
a receiver, for receiving voice and data via respective spectral regions of said communications channel from said desired wireless device; and
means for changing said communication channel utilized by said transmitter in response to an indication that data transmitted via said transmitter said desired wireless device fails to satisfy at least one criterion:

2. The apparatus of claim 1, wherein said indication of inappropriate data transmission comprises a received signal strength indicator (RSSI) below a threshold level.

3. The apparatus of claim 1, wherein said indication of inappropriate data transmission comprises at least one of a poor RSSI, a corrupted ID code, an incorrect ID code and a low battery indication.

4. A computer readable medium containing software instructions that, when executed by a processor, performs the steps of:
simultaneously transmitting available audio and identification data in respective spectral regions modulated onto a radio frequency (RF) carrier signal of a communication channel; and
in the absence of a favorable response from a wireless device corresponding to said identification data, selecting a next communication channel.

5. In a wireless communications system utilizing a plurality of communications channels, each channel having associated with it a respective carrier frequency for propagating audio data in a first spectral region and non-audio data in a second spectral region, a method comprising:
(a) selecting an initial communications channel for communicating with a desired wireless device;
(b) determining if a received signal strength indicator (RSSI) of said selected communications channel indicates that said desired wireless device is active; and, if so
(c) transmitting, via said selected communications channel, an identification code of said active wireless device, said identification code comprising non-audio data; otherwise
(d) repeating step (c) up to a predetermined number of times until said desired wireless device has responded to said transmitted identification code; and
(e) if said desired wireless device has not responded to said transmitted identification code, selecting(430) a next communications channel and repeating steps (b) through (d).

6. The method of claim 5, wherein said wireless communications system comprises a 900 MHz region cordless telephone system.

7. The method of claim 5, wherein said wireless communications system comprises a 2.4 GHz region cordless telephone system.

8. The method of claim 5, wherein said identification code is transmitted simultaneously with audio data.

9. The method of claim 5, further comprising:
(f) determining if a received response from said wireless device has associated with it an error condition; and
(g) in the event of said error condition indicating improper wireless device operation, displaying a message indicative of said improper operation on a display device.

10. The method of claim 9, further comprising:
(h) in the event of said error condition indicating a degraded communications channel, selecting a next communications channel and repeating steps (B) through (d).

11. The method of claim 9, wherein said error condition comprises at least one of a poor RSSI, a corrupted ID code, an incorrect ID code and a low battery indication.

12. The method of claim 9, wherein said error condition comprises a poor RSSI.

13. A method, comprising:
simultaneously transmitting available audio and identification data in respective spectral regions modulated onto a radio frequency (RF) carrier signal of a communication channel; and
in the absence of a favorable response from a wireless device corresponding to said identification data, selecting a next communication channel.

14. The method of claim 13, further comprising:
in the event of receiving a response including within it an error condition indicative of improper wireless device operation, displaying a message indicative of said improper wireless operation on a display device.

15. The method of claim 14, wherein in the event of said error condition indicating a degraded communications channel, selecting a next communications channel.

16. The method of claim 13, further comprising:
in the event of receiving a response including within it an error condition indicative of improper wireless device operation, selecting a next communications channel.

17. The method of claim 16, wherein said error condition comprises at least one or a poor RSSI, a corrupted ID code, an incorrect ID code and a low battery indication.
